(19) United States
(12) Patent Application Publication
(10) Pub. No.: US 2014/0156977 A1
(43) Pub. Date: Jun. 5, 2014

(54) ENABLING AND DISABLING A SECOND JUMP EXECUTION UNIT FOR BRANCH MISPREDICTION

(71) Applicants: Mark J. Dechene, Hillsboro, OR (US); Matthew C. Merten, Hillsboro, OR (US); Sean P. Mirkes, Beaverton, OR (US)

(72) Inventors: Mark J. Dechene, Hillsboro, OR (US); Matthew C. Merten, Hillsboro, OR (US); Sean P. Mirkes, Beaverton, OR (US)

(21) Appl. No.: 13/994,699

(22) PCT Filed: Dec. 28, 2011
(86) PCT No.: PCT/US11/67658

§ 371 Date: Jun. 14, 2013

(51) Int. Cl. G06F 9/38

(52) U.S. Cl. CPC G06F 9/3861
USPC 712/239

(57) ABSTRACT

Techniques are described for enabling and/or disabling a secondary jump execution unit (JEU) in a micro-processor. The secondary JEU is incorporated in the micro-processor to operate concurrently with a primary JEU, and to enable the handling of simultaneous branch mispredicts on multiple branches. Activation and deactivation of the secondary JEU may be controlled by a pressure counter or a confidence counter. A pressure counter mechanism increments a count for each branch operation executed within the processor and decrements the count by a decay value during each cycle. A confidence counter mechanism increments a count for each correctly predicted branch, and decrements the count for each mispredict. Each counter signals an activation component, such as a port binding hardware component, to begin binding micro-operations to the secondary JEU when the counter exceeds an activation threshold. The counter mechanism may be thread-agnostic or thread-specific.

### TECHNICAL FIELD

Embodiments generally relate to instruction processing within a micro-processor, and more particularly to the handling of branch operation misprediction in a micro-processor.

### BACKGROUND ART

Microprocessors employ branch prediction to improve performance. Traditional processor architectures include one or more branch predictors in the form of a digital circuit that predicts which way a code branch instruction (e.g., an if-then-else block, another conditional, or a jump statement) will proceed prior to its execution. A subsequent unit may then execute the branch instruction and validate the results of the branch prediction. This branch result validation circuit is often referred to as a branch execution unit or jump execution unit. Based on the branch prediction, one or more micro-operations that follow the predicted branch in program order may be fetched, scheduled, and/or speculatively executed. Without branch prediction, the processor may operate less efficiently given that it would have to wait until the branch or jump instruction has executed (e.g., until it has determined which program path to follow) before determining subsequent instructions to fetch. Thus, branch prediction enables an improved flow in an instruction pipeline of a processor.

Unfortunately, there are instances when a branch predictor circuit mispredicts the branch (i.e., predicts incorrectly). In such cases, the processor performs a clearing process to remove those micro-operations that were fetched, scheduled to execute, partially executed, and/or fully executed in anticipation of the branch being followed. The speed of mispredict detection, the execution of the clearing process, and the subsequent fetching, scheduling, and execution of the correct instructions has a direct impact on performance of a processor.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an example architecture for a micro-processor, in accordance with embodiments.

FIG. 2 is a schematic diagram depicting an example computing system in which the micro-processor of FIG. 1 may operate.

FIG. 3 depicts a flow diagram of an illustrative process for handling branch mispredicts from a first and second jump execution unit, in accordance with embodiments.

FIG. 4 depicts a schematic diagram of instruction pipelines in a process of handling branch mispredicts from a first and second jump execution unit, in accordance with embodiments.

FIG. 5 depicts a flow diagram of an illustrative process for handling branch mispredicts from a first and second jump execution unit and a nuke instruction from a reorder buffer, in accordance with embodiments.

FIG. 6 depicts a schematic diagram of instruction pipelines in a process of handling branch mispredicts from a first and second jump execution unit and a nuke instruction from a reorder buffer, in accordance with embodiments.

FIG. 7 depicts a flow diagram of an illustrative process for promoting a second jump execution unit, in accordance with embodiments.

FIG. 8 depicts a schematic diagram of instruction pipelines in a process of promoting a second jump execution unit, in accordance with embodiments.

FIG. 9 depicts a flow diagram of an illustrative process for handling branch mispredicts from a first and second jump execution unit and detection of an older mispredict, in accordance with embodiments.

FIG. 10 depicts a schematic diagram of instruction pipelines in a process of handling branch mispredicts from a first and second jump execution unit and detection of an older mispredict, in accordance with embodiments.

FIG. 11 illustrates an example architecture for a micro-processor, in accordance with embodiments.

FIG. 12 depicts a flow diagram of an illustrative process for activating and/or deactivating a second jump execution unit by employing a pressure counter, in accordance with embodiments.

FIG. 13 depicts a flow diagram of an illustrative process for activating and/or deactivating a second jump execution unit by employing a confidence counter, in accordance with embodiments.

### DETAILED DESCRIPTION

### Overview

Techniques are described for enabling and disabling a second jump execution unit (JEU) of a processor. As described below, embodiments support a second JEU that operates concurrently and/or in parallel with a first JEU to concurrently execute branches, and/or concurrently detect branch mispredicts on a first JEU and a second JEU. A code branch executes in a JEU of a processor, and after execution the actual branch direction is compared to the previously predicted branch direction to determine whether a mispredict has occurred. A certain amount of time (e.g., four instruction cycles) elapses from when a branch is scheduled to execute until it actually executes and a mispredict is potentially detected. During that time period, various units of the processor are informed that a JEU is preparing to execute a branch and that those units should therefore be prepared, in the event of a mispredict, to back out all micro-operations younger than the branch (e.g., operations that were fetched after the branch) because they were incorrectly speculated and are not from the proper program path.

When a mismatch between the actual branch direction and the predicted branch direction is detected, a mispredict is signaled and a clearing process is initiated to clear the incorrectly speculated micro-operations from the processor. In some embodiments, this clearing process is a core-wide clearing process to clear the core of all micro-operations younger than the branch. The speed at which a processor detects mispredicts and clears the incorrectly speculated micro-operations may be critical for processor performance. In general, branches may potentially execute out of order, and the clearing process may begin immediately after the mispredict is detected instead of waiting for the branch to retire.

When executing certain programs, it may be advantageous to execute two branches per cycle and evaluate two branches per cycle for any mispredicts, such as when running multi-threaded programs with two independently executing threads, single-threaded programs with a high density of branch operations, or in other situations. However, previous processor micro-architectures may be limited to initiating only one core-wide clearing process per instruction cycle. Given that, it may be advantageous in some situations to be able to handle concurrently detected branch mispredicts while still supporting existing micro-architectural elements that enable the initiation of a single core-wide clearing process per cycle.

Therefore, embodiments described herein support a second JEU in a processor to provide for concurrent branch evaluation with a first JEU, and support concurrent branch mispredicts by allowing the second JEU to employ the mispredict signaling mechanisms available to the first JEU. In some embodiments, the second JEU is a low-cost JEU that has reduced functionality compared to the first JEU. For example, the first JEU may have connections to other units of the processor core and accordingly be able to signal to the other units that they should prepare for a possible mispredict and to signal the other units when a mispredict occurs. In some embodiments, the second JEU lacks such capability. Moreover, in some embodiments the second JEU is further limited in that it supports certain types of branches, such as branches that are predicted to fall through (e.g., such that the fetch unit predicted that the condition was not true and continued fetching code at the instruction after the branch). Also, in some embodiments the second JEU may support certain subsets of branch conditions, may be limited to supporting unconditional branches, and/or may be unable to support indirect branches.

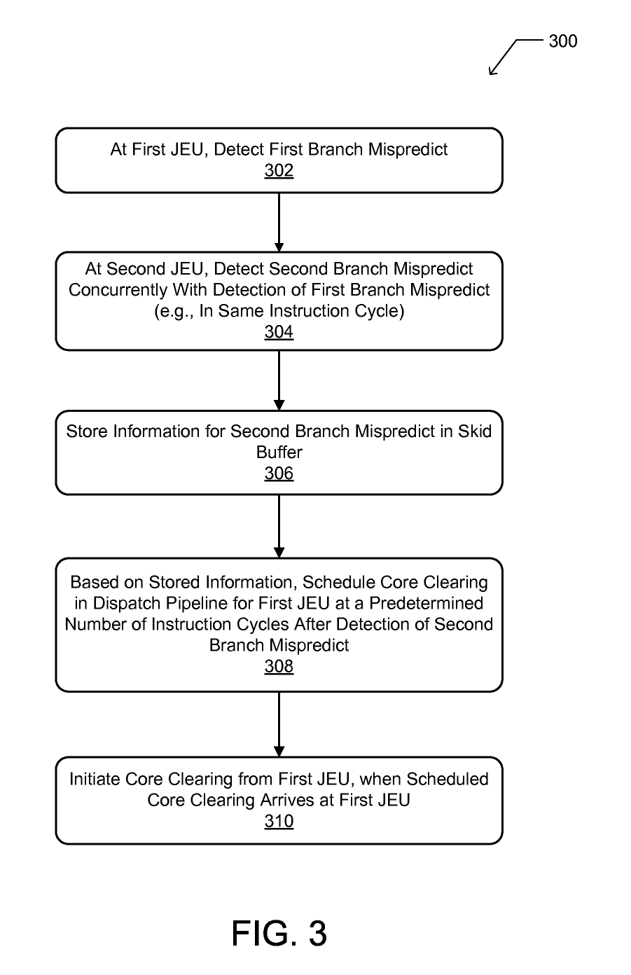

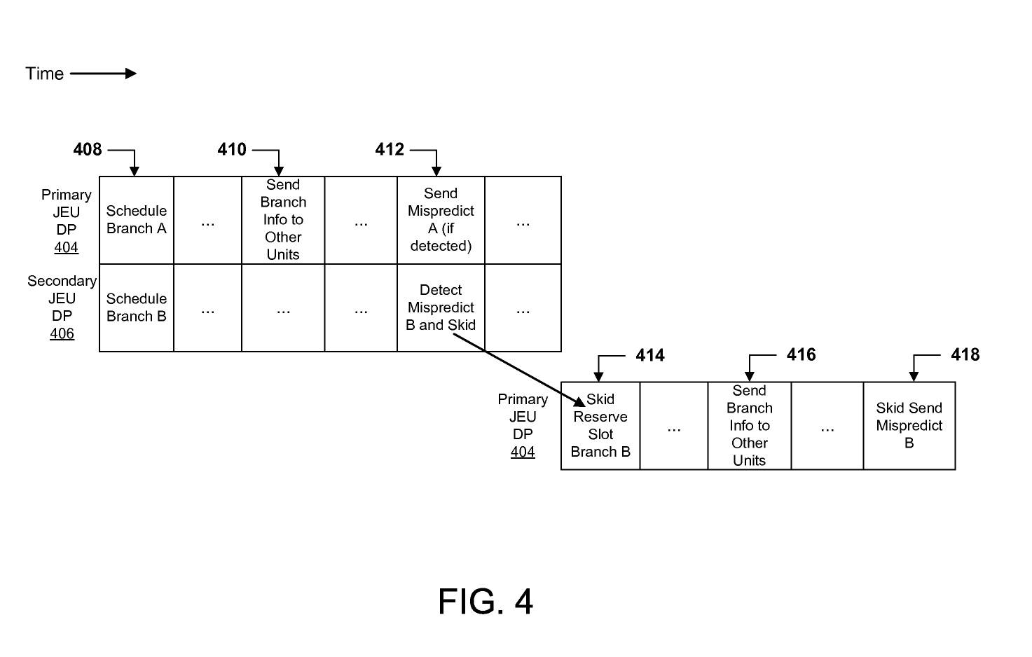

Embodiments are described herein for four different example scenarios that employ the second JEU in conjunction with the first JEU. In a first example scenario, two branch mispredicts are detected concurrently (e.g., in a same instruction cycle) by the first and second JEUs. In this case, the second JEU triggers the scheduling of its branch processing and a core-wide clearing process into the first JEU's dispatch pipeline a certain number of instruction cycles later than the first JEU's branch processing. This later scheduling is referred to herein as a skid process. This first example scenario is described further herein with regard to FIGS. 3 and 4.

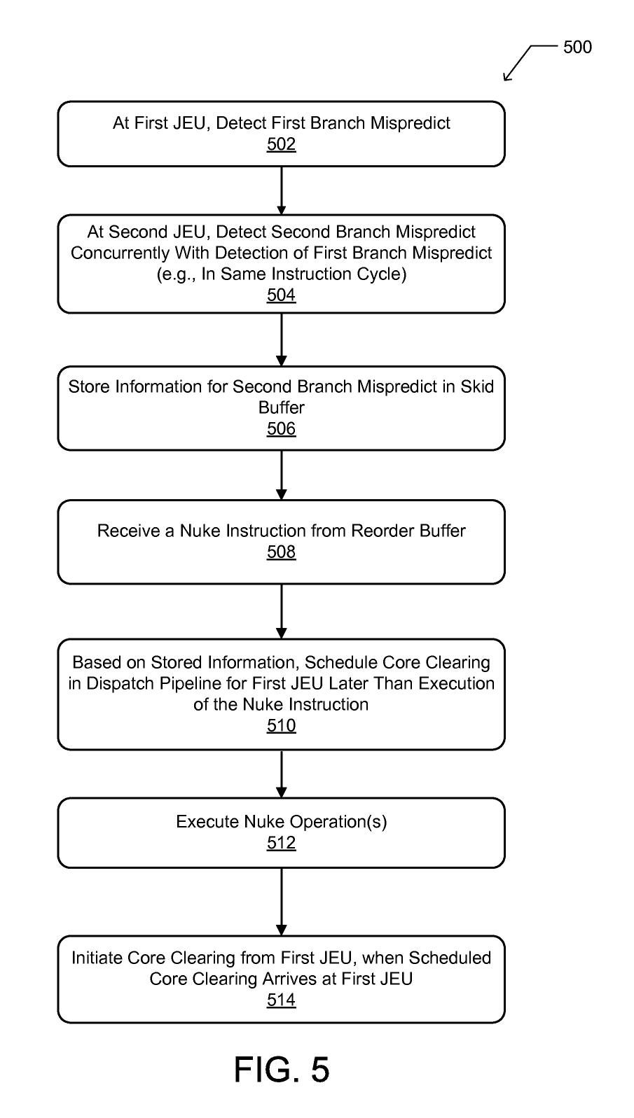

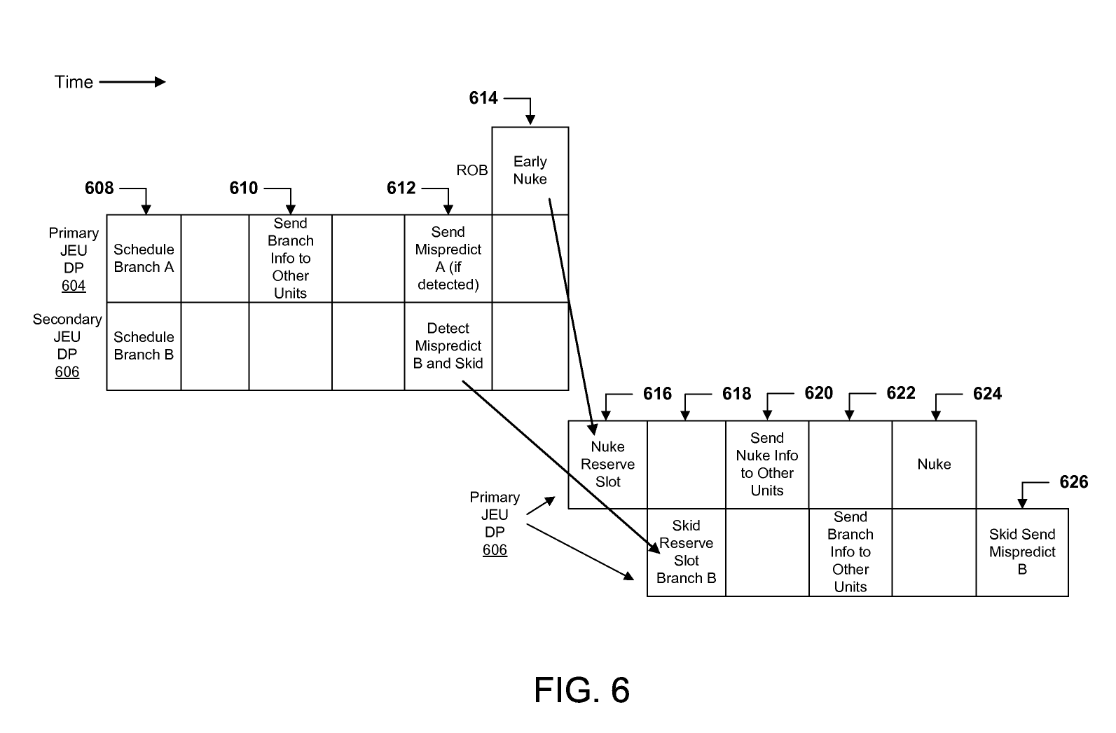

In a second example scenario, a branch mispredict on the second JEU causes a skid dispatch to be requested on the first JEU at the same time as a “nuke” command is received from another unit of the processor such as a reorder buffer (ROB), and the nuke also requests the same dispatch slot on the first JEU (e.g., a nuke-skid collision). As used herein, a nuke is a command to remove all unretired micro-operations currently in the machine for the specified thread. In some embodiments, the ROB may send such a message when there is an interrupt or other type of event that necessitates flushing the pipeline. When a nuke is detected, a dispatch slot on the first JEU is reserved for the nuke. Because the nuke mechanism uses the same clearing protocol as a branch mispredict, there may be no simultaneous mispredict on that cycle on the same port. Therefore, when there is a collision between nuke and skid the branch processing for the second branch mispredict is skidded farther down the pipeline and scheduled to occur after the processing of the nuke command (e.g., delayed one cycle). This example scenario is discussed further herein with regard to FIGS. 5 and 6.

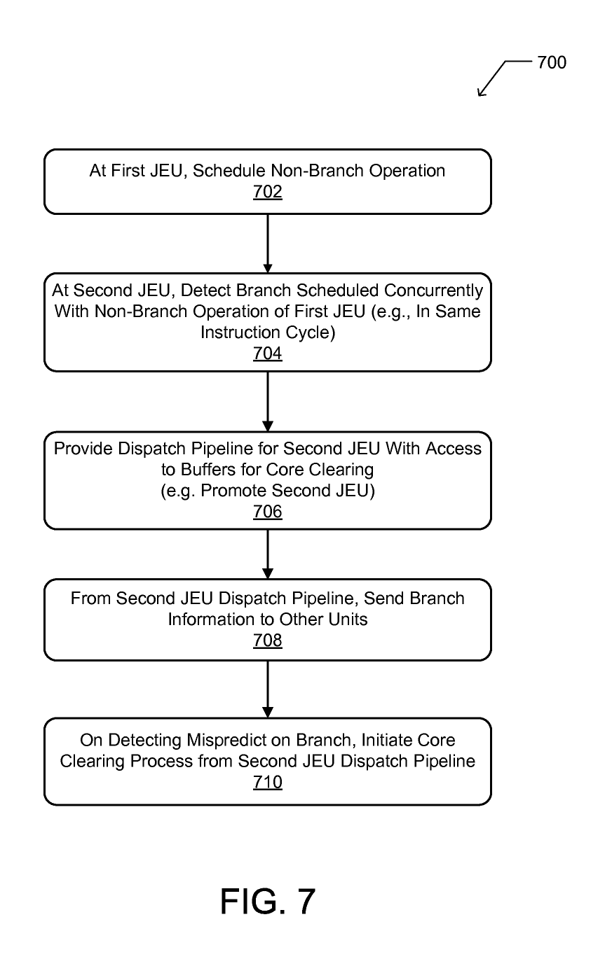

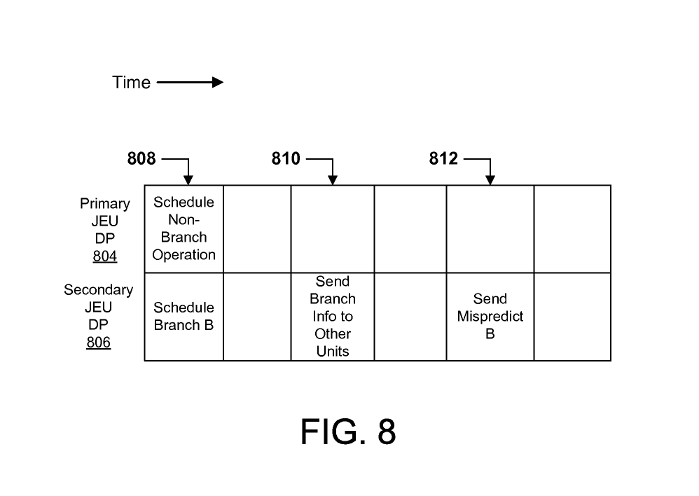

In a third example scenario, the second JEU is promoted to have access to the mispredict mechanisms normally accessible to the first JEU. In some embodiments, all communications about a mispredict are processed through the first JEU. However, in some cases when the first JEU has a non-branch micro-operation scheduled (e.g., an add operation), the second JEU is promoted to take control of the various buffers for handling a mispredict. In such cases, the second JEU is in effect acting as though it is the first JEU, until it has completed its operations related to processing the branch and/or the branch mispredict. This example scenario is discussed further herein with regard to FIGS. 7 and 8.

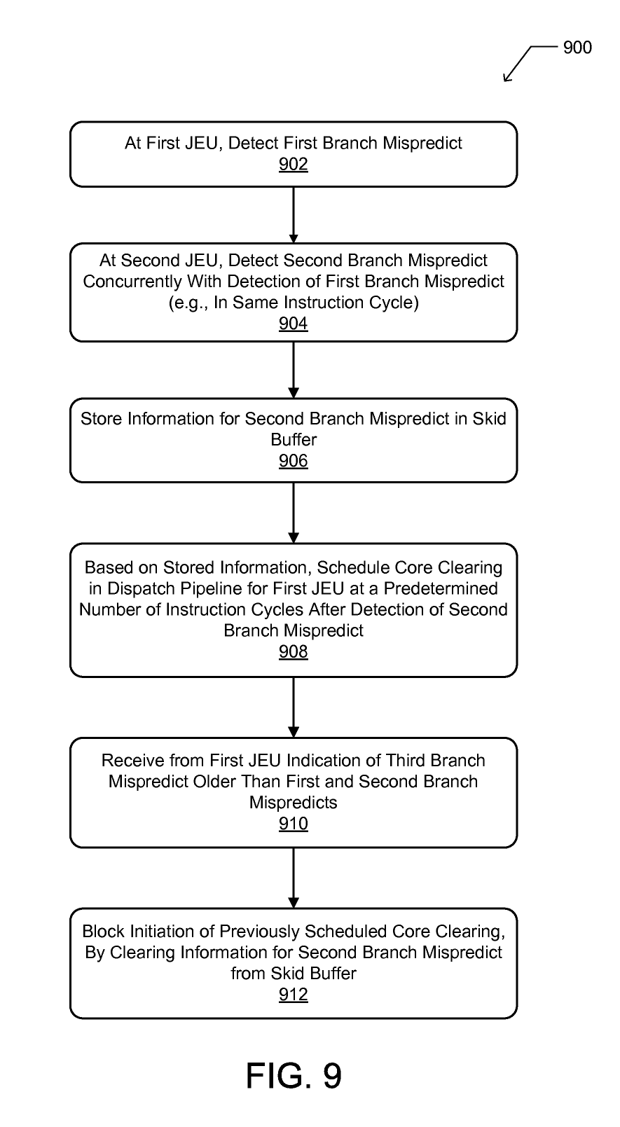

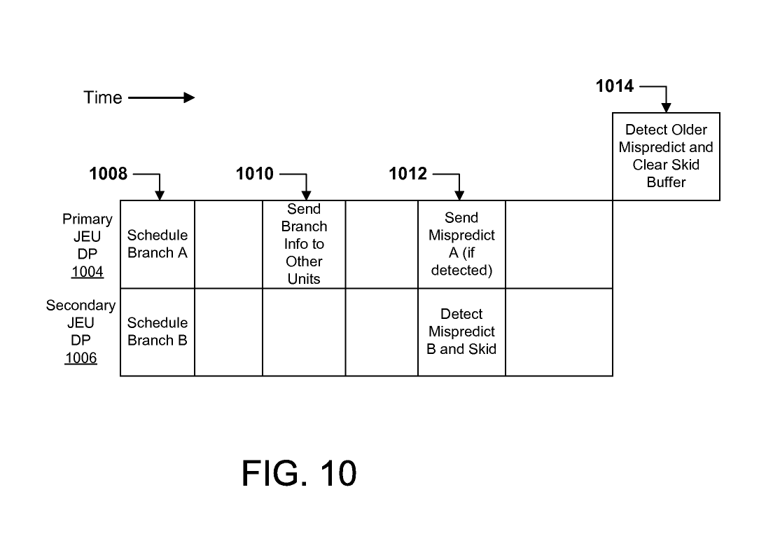

The fourth example scenario is similar to the first example scenario, but with an added element of an older mispredict detected on the first JEU after the second JEU skids a mispredict but before the second JEU's mispredict takes control of the first JEU's controls to initiate the core-wide clearing process described above. In this scenario, all operations younger than this newly detected older mispredict are cleared out, including the skidded second JEU branch operations. A similar yet somewhat different process may be performed when an older nuke command is received from the ROB. These examples are described further herein with regard to FIGS. 9 and 10.

In some cases, mispredicts detected on the second JEU may take longer to clear, to put the processor back onto a correct execution path. Consequently, although operation of the second JEU may provide advantages as described herein, it may also adversely affect program performance. For at least this reason embodiments support the enabling and/or disabling of the second JEU in various circumstances, to balance more timely execution and evaluation of branch instructions with the possibility of a delayed triggering of a mispredict.

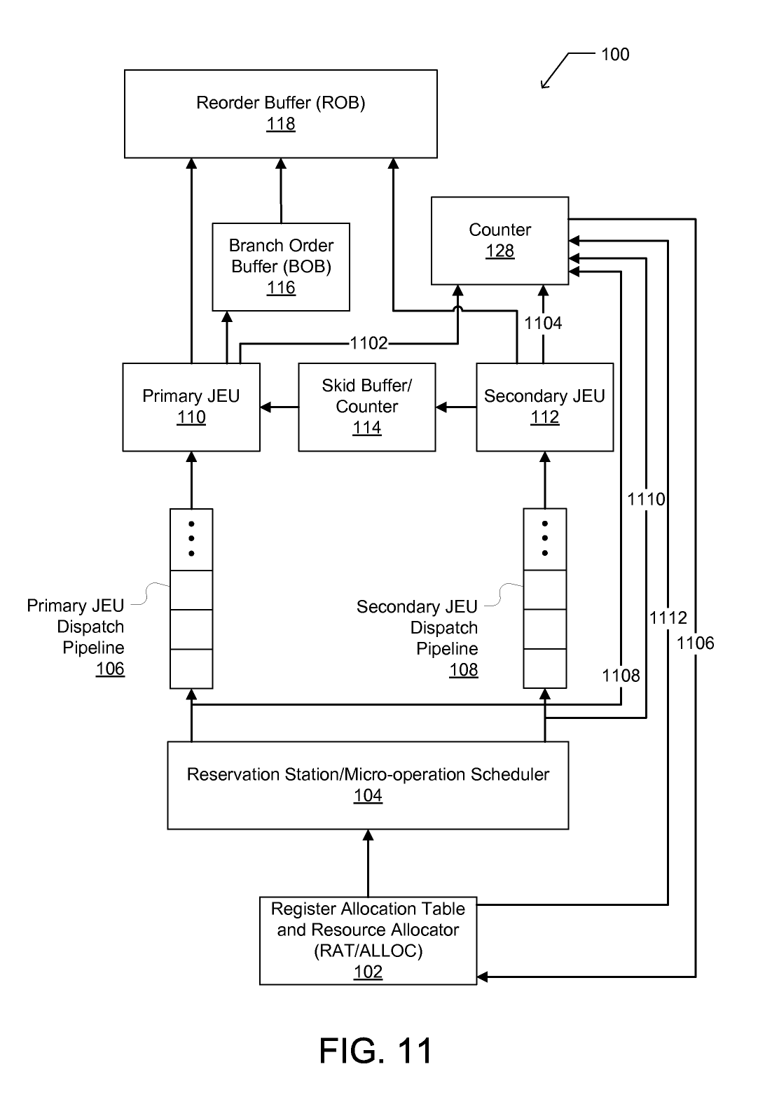

In some embodiments, the activation and/or deactivation of the second JEU may be controlled by a pressure counter or a confidence counter. A pressure counter mechanism increments a count for each branch operation executed within the processor and decrements the count by a decay value during each cycle. A confidence counter mechanism increments a count for each correctly predicted branch, and decrements the count for each mispredict. Each counter signals an activation component, such as port binding logic in register allocation table and resource allocator (RAT/ALLOC) component, to begin binding micro-operations to the second JEU when the counter exceeds a threshold. The counter mechanism may be thread-agnostic or thread-specific. Activation and deactivation of the second JEU is described further herein with reference to FIGS. 11-13.

In the descriptions below, the first and second JEUs are referred to alternatively as primary and secondary JEUs. However, this identification of primary and secondary JEUs is not in itself intended as a limiting description of these components.

### Illustrative Processor Architecture

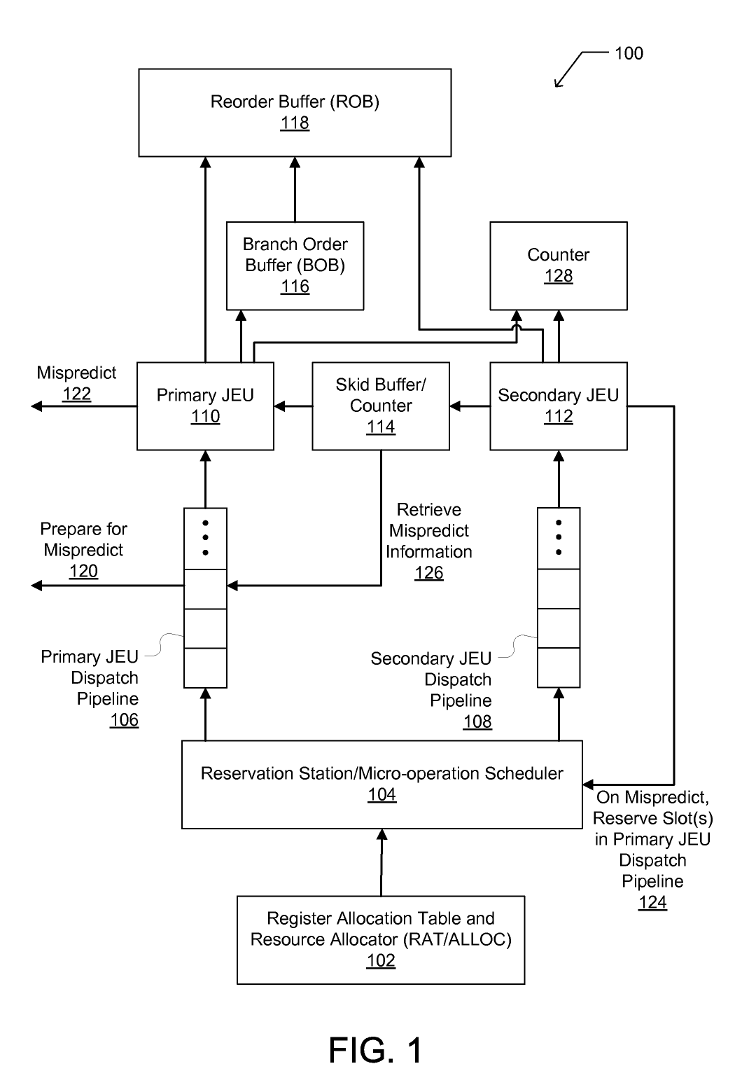

FIG. 1 depicts an example micro-architecture for a microprocessor (also referred to herein as a processor or processing unit). In the example shown, processor architecture 100 includes a register allocation table and resource allocator (RAT/ALLOC) 102, which operates to bind micro-operations to one of the available dispatch ports and registers of the processor. RAT/ALLOC 102 communicates with reservation station/micro-operation scheduler 104 of the processor, generally referred to herein as a scheduler. In some embodiments, scheduler 104 schedules incoming micro-operations, including branch operations, for execution.

Each branch operation may be scheduled by the scheduler 104 to execute in one of the JEUs. As described above, architecture 100 with two JEUs operating in parallel enables two branch mispredicts to be detected concurrently (e.g., in a single instruction cycle) and processed as described further herein. As shown in FIG. 1, architecture 100 includes two JEUs—primary JEU 110 and secondary JEU 112, associated with primary JEU dispatch pipeline (DP) 106 and second JEU DP 108 respectively. Scheduler 104 schedules micro-operations to execute in primary JEU 110 or secondary JEU 112 by writing the micro-operations into primary JEU DP 106 or secondary JEU DP 108 respectively.

In some embodiments, secondary JEU 112 does not have access to the buffers and/or mechanisms for initiating the core-wide clearing process when a branch mispredict is directed. Therefore, when it detects a mispredict for a branch operation, secondary JEU 112 may write information associated with the mispredict into skid buffer/counter 114. This information may include a target address as well as information to assist in updating the branch predictors with the actual outcome, to improve future predictions. The information saved in skid buffer/counter 114 may then be used to initiate the core-wide clearing process.

Further, architecture 100 may include a branch order buffer (BOB) 116. In some embodiments, BOB 116 maintains an entry that stores address information for each branch operation in a currently executing program. When a branch operation executes in primary JEU 110, address information for the taken branch (e.g., the actually taken target of the branch) is written to BOB 116. When the branch operation retires, target address information (e.g., the address of a next instruction to execute) may then be retrieved from the BOB 116. Then, the BOB 116 may communicate that information to a reorder buffer (ROB) 118, which keeps track of a current position within the currently executing program. Thus, for each taken branch, BOB 116 may update ROB 118 with address information for the next instruction after the branch in program order, so that the ROB 118 may update the current position within the program.

In some embodiments, the primary JEU 110 has the ability to write to either the BOB 116 or the ROB 118. However, the secondary JEU 112 may not able to write a taken target to BOB 116, though it may be able to write to ROB 118 to mark a branch as executed and complete. Thus, the secondary JEU 112 may be described as a low-cost JEU with somewhat more limited capabilities than those of the primary JEU 110.

Though not shown in FIG. 1, in some embodiments secondary JEU 112 may have a limited ability to write to the BOB 116, which is acceptable in cases where the secondary JEU 112 is executing a predicted fall-through branch (e.g., a branch where a correct prediction simply requires the ROB to advance the instruction pointer to the next instruction). If a predicted fall-through branch mispredicts, two actions may occur. First, a clearing process may be initiated. Second, the correct taken target may be written into the BOB. Because the first action may not be performed from the secondary JEU and is skidded to the primary JEU, the BOB may be updated later from the primary JEU. This enables embodiments in which the secondary JEU has no need to ever write to the BOB. If predicted taken branches were to be allowed on the secondary JEU this may obviate the low-cost benefits of the secondary JEU, given that a correct prediction would need to write the taken target to the BOB so the ROB can properly update the instruction pointer.

Moreover, in some embodiments secondary JEU 112 may be promoted so that it has the ability to write to the BOB 116 and ROB 118, and the ability to initiate a core-wide clearing process in response to a detected mispredict and write to the BOB 116. This promotion scenario is described in greater detail below with regard to FIGS. 7 and 8.

As further shown in FIG. 1, primary JEU DP 106 may have the ability to send to one or more other components of the processor a prepare-for-mispredict message 120. In some embodiments, this warning to prepare for a possible mispredict includes sending to the other components information regarding the branch operation that is executing so that the other components may prepare to back out all micro-operations that are younger than the branch in the event of a mispredict. For example, a message may be sent from the DP to a fetch unit to be prepared to start fetching from a new address, to the RAT/ALLOC to restore the ROB allocation pointer to the point of the mispredict (i.e., backing out incorrectly speculated operations), and/or to the reservation station to determine which micro-operations to clear from the structure that are younger than the mispredicting branch. Then, if a mispredict is detected, the primary JEU 110 may send a mispredict message 122 to the other components informing them that a mispredict has occurred and that they may back out the younger operations.

As shown in this example, primary JEU 110 and primary JEU DP 106 have the ability to send the mispredict message 122 and the prepare-for-mispredict message 120 respectively, but the secondary JEU 112 and its DP do not have this ability. Thus, secondary JEU 122 may employ the mechanisms of the primary JEU 110 to initiate a core-wide clearing process to clear the core of those instructions that are younger than the second branch, when a mispredict is detected by secondary JEU 112. In such cases, the secondary JEU 112 may send a message 124 to the scheduler 104 to reserve one or more slots in primary JEU DP 106 to send a prepare-for-mispredict message 120 and to initiate the core-wide clearing process by sending a mispredict message 122. When those reserved slots arrive in the primary JEU DP 106, information regarding the mispredict is retrieved from skid buffer/counter 114 in a retrieve-mispredict-information message 126. This process of the secondary JEU 112 using the mispredict mechanisms of primary JEU 110 is referred to herein as skidding, and is described in greater detail below.

In some embodiments, processor architecture 100 further includes counter 128, which operates to determine when to enable and/or disable the secondary JEU 112. As shown in FIG. 1, counter 128 may communicate with primary JEU 110 and/or secondary JEU 112, and may receive information from each JEU regarding executed branch operations. This information may include data regarding a number of branch operations executed and/or a number of branch mispredicts detected. Although not depicted in FIG. 1, counter 128 may further communicate with other components of architecture 100. Operations of counter 128 are described further herein with regard to FIGS. 11-13.

### Illustrative Computing System

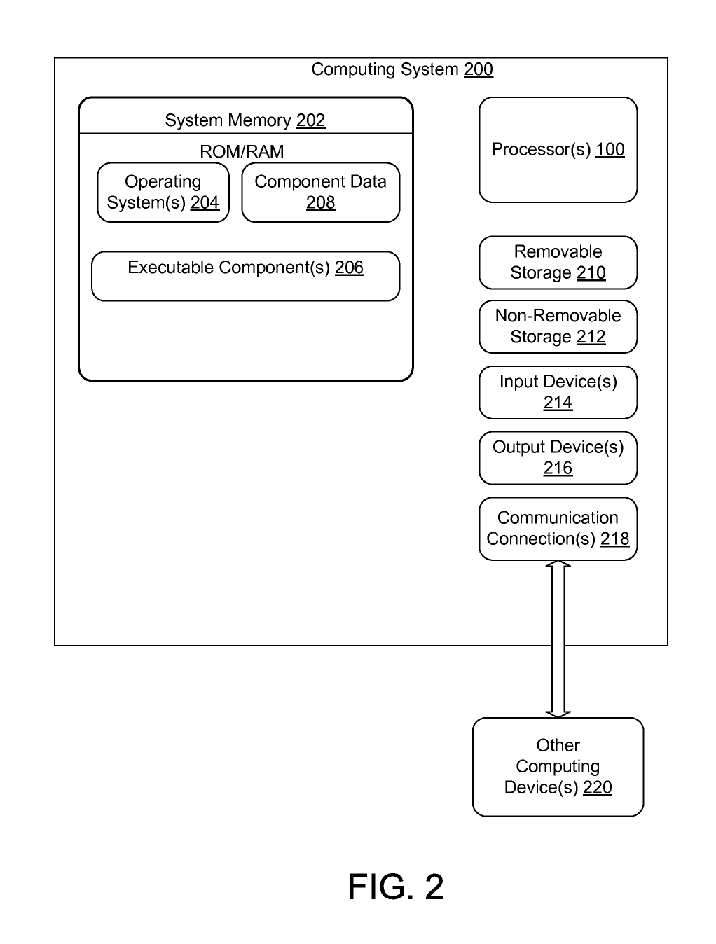

FIG. 2 depicts a diagram for an example computer system (e.g., one or more computing devices or apparatuses) that employs one or more processors with the processor architecture 100 shown in FIG. 1. One or more processors 100 may include computer-executable, processor-executable, and/or machine-executable instructions written in any suitable programming language to perform various functions described herein. Computing system 200 may also include a system memory 202, which may include volatile memory such as random access memory (RAM), static random access memory (SRAM), dynamic random access memory (DRAM), and the like. System memory 202 may further include non-volatile memory such as read only memory (ROM), flash memory, and the like. System memory 202 may also include cache memory. As shown, system memory 202 includes one or more operating systems 204, which may provide a user interface including one or more software controls, display elements, and the like.

System memory 202 may also include one or more executable components 206, including components, programs, applications, and/or processes, that are loadable and executable by processor(s) 100. System memory 202 may further store program/component data 208 that is generated and/or employed by executable component(s) 206 and/or operating system(s) 204 during their execution.

As shown in FIG. 2, computing system 200 may also include removable storage 210 and/or non-removable storage 212, including but not limited to magnetic disk storage, optical disk storage, tape storage, and the like. Disk drives and associated computer-readable media may provide non-volatile storage of computer readable instructions, data structures, program modules, and other data for operation of computing system 200.

In general, computer-readable media includes computer storage media and communications media.

Computer storage media includes volatile and non-volatile, removable and non-removable media implemented in any method or technology for storage of information such as computer readable instructions, data structure, program modules, and other data. Computer storage media includes, but is not limited to, RAM, ROM, erasable programmable read-only memory (EEPROM), SRAM, DRAM, flash memory or other memory technology, compact disc read-only memory (CD-ROM), digital versatile disks (DVDs) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave or other transmission mechanism. As defined herein, computer storage media does not include communication media.

Computing system 200 may include input device(s) 214, including but not limited to a keyboard, a mouse, a pen, a game controller, a voice input device for speech recognition, a touch input device, a camera device for capturing images and/or video, one or more hardware buttons, and the like. Computing system 200 may further include output device(s) 216 including but not limited to a display, a printer, audio speakers, a haptic output, and the like. Computing system 200 may further include communications connection(s) 218 that allow computing system 200 to communicate with other computing device(s) 218, including client devices, server devices, databases, and/or other networked devices available for communication over a network.

### Illustrative Skid Operations

FIGS. 3, 5, 7, 9, 12, and 13 depict flowcharts showing example processes in accordance with various embodiments. The operations of these processes are illustrated in individual blocks and summarized with reference to those blocks. The processes are illustrated as logical flow graphs, each operation of which may represent one or more operations that can be implemented in hardware, software, or a combination thereof. In the context of software, the operations represent computer-executable instructions stored on one or more computer storage media and/or stored internally on one or more processors. Such instructions, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order, subdivided into multiple sub-operations, and/or executed in parallel to implement the described processes. The example processes illustrated by FIGS. 3, 5, 7, and 9 may be executed by one or more of the components included in processor architecture 100.

FIG. 3 depicts an example process 300 for handling branch mispredicts that are detected concurrently in a first JEU and a second JEU, in accordance with embodiments. As described above, a processor supporting embodiments may incorporate a primary JEU and a secondary JEU. A micro-operation scheduler (such as scheduler 104) may schedule two different branch operations of a program to execute in these two different JEUs more or less concurrently. In some embodiments, the program may be running in a multi-threaded mode, and the two different branch operations may be executing within different threads. In some embodiments, the two branch operations may be executing within a same thread.

At 302 a first branch mispredict is detected at the first JEU (e.g., the primary JEU). At 304 a second branch mispredict is detected at a second JEU (e.g., the secondary JEU) concurrently with the detection of the first branch mispredict at the first JEU. In some embodiments, detection of the two branch mispredicts may occur within a same instruction cycle of the processor. As described above, when a branch mispredict is detected a core-wide clearing process is initiated to instruct other components of the processor to remove micro-operations younger than the branch.

Because the second JEU does not have access to the mechanisms for initiating the core-wide clearing process, one or more skid operations are performed to enable an initiation of the core-wide clearing process using mechanisms available to the first JEU. These skid operations are described in more detail with regard to FIG. 4. At 306, information for the second branch mispredict is stored in a skid buffer such as skid buffer/counter 114. In cases where the mispredict on the second JEU is younger than that on the first JEU and on the same thread, the second mispredict may not be written to the skid buffer given that the clearing caused by the first mispredict will automatically cause the clearing of those operations that were incorrectly speculated due to the second mispredict.

At 308 a core-wide clearing process is scheduled in the DP for a first JEU, based on the information stored in the skid buffer at 306. As described above, this core-wide clearing process clears the core of instructions that are younger than the second branch. In some embodiments, the core-wide clearing process is scheduled at a predetermined number of instruction cycles after detection of the second branch mispredict by the second JEU. At 310 the core clearing is initiated from the first JEU when the scheduled core clearing instructions arrive at the first JEU.

FIG. 4 depicts an example set of instructions flowing down the dispatch and execution pipelines which have concurrently detected branch mispredicts, according to embodiments. This example depicts a five-stage process for handling a branch operation in a JEU during five cycles in an instruction pipeline. During this five-stage process, a branch may be scheduled to execute and other components of the processor may be informed that a branch is scheduled and warned that a mispredict may occur (e.g., they are sent a prepare-for-mispredict message 120). In the embodiment illustrated in FIG. 4 (and FIGS. 6, 8, and 10), the columns correspond to and depict cycles for instructions and/or micro-operations flowing down the dispatch and execute pipelines. In FIG. 4 (and FIGS. 6, 8, and 10) time progresses from left to right as instruction cycles further to the right in the diagram are processed later in time.

The rows of FIG. 4 depict instructions in primary JEU DP 404 and secondary JEU DP 406 respectively. At column 408 a first branch operation (e.g., Branch A) is scheduled in primary JEU DP 404 and a second branch operation (e.g., Branch B) is scheduled in secondary JEU DP 406. In this example, Branch A and Branch B are scheduled in a same instruction cycle. At column 410 prepare to mispredict information for Branch A is sent to other units (e.g., other components of the processor) from the primary JEU. At column 412 a mispredict is detected for Branch A concurrently with a mispredict detected for Branch B (e.g., during the same instruction cycle as shown).

At this stage, the primary JEU sends a message (e.g., mispredict message 122) informing the other components of the processor that a mispredict has been detected for Branch A, and initiating the core-wide clearing process. However, because a single mispredict may be signaled in a particular instruction cycle, the detected mispredict on Branch B triggers a skid by which the five-stage branch process is scheduled later in the primary JEU DP 404 to occur after the five-stage process for Branch A. In the example depicted, at column 414 the skid is scheduled and a slot is reserved for Branch B two instruction cycles after the mispredict is signaled for Branch A. Then, the other stages of the five-stage process are scheduled as part of the skid. For example, at column 416 branch information for Branch B is sent to the other units of the processor to inform them that Branch B may mispredict. At column 418 the mispredict signal for Branch B is sent, informing the other units that a mispredict has occurred. In this way, the skid process reschedules the five-stage branch process to occur later in the primary JEU pipeline, enabling two simultaneously detected branch mispredicts to be processed one after another using the primary JEU's mechanisms for signaling a mispredict.

In some embodiments, the skid process is such that the core-wide clearing corresponding to Branch B is scheduled to occur at a predetermined number of cycles after detection of the Branch B mispredict. For example, this predetermined number may be set at six cycles. In the example, to accomplish this, the dispatch slot on the primary JEU is reserved two cycles after Branch B mispredicts in the secondary JEU to ensure that no other operations are being executed on the primary JEU when the Branch B mispredict is signaled. In this way, the skidding process may be described as self-timed, such that the skid for Branch B is scheduled at a predetermined number of instruction cycles later than the initially scheduled processing of Branch B in the secondary JEU DP. In other embodiments, Branch B may be re-dispatched and re-executed from scratch, rather than relying on skid buffers.

In some embodiments, the skid mechanism is employed in cases when the primary and secondary JEUs are simultaneously executing branch operations in a same program thread. When the primary JEU's branch is younger in program order than the secondary JEU's branch, initiating a core clearing based on the primary JEU's branch fails to clear out operations speculatively fetched, scheduled, and/or executed for the second branch prediction. Thus, the secondary JEU's branch may be skidded to ensure that such operations are cleared. However, when the primary JEU's branch is older in program order than the secondary JEU's branch, a skid may not be performed given that the core clearing initiated by the first branch mispredict on the primary JEU also clears operations related to the second branch on the secondary JEU.

In another example, in cases when the primary and secondary JEUs are executing branch operations in separate, independent threads and both branches mispredict, the branch for the secondary JEU is skidded to ensure successful core clearing for the second branch mispredict. Moreover, in some cases two branches may be scheduled to execute concurrently on the primary and secondary JEUs, and the second branch mispredicts but the first branch does not mispredict. In these scenarios, the secondary JEU did not send the prepare-to-mispredict signal and has no access to the core clearing controls, so a skid is triggered to enable the secondary JEU access to the core clearing functionality of the primary JEU according to the mechanism described.

### Illustrative Operations for Nuke/Skid Collision

In some cases a branch mispredict is detected on the secondary JEU, and additionally the ROB signals a nuke command to remove all micro-operations currently in the DP. As described above, the ROB may send a nuke when there is an interrupt or other type of event that necessitates flushing the pipeline. As described above, such cases may be described as a collision between the nuke and the secondary JEU skid request given that both the nuke and the secondary JEU mispredict may both attempt to employ mechanisms of primary JEU DP to perform their respective operations. Therefore, embodiments provide a means to detect when such a collision takes place and account for it by skidding the branch processing for the second branch mispredict farther down in the primary JEU DP, so that it is scheduled to occur after the processing of the nuke command. This scenario is illustrated in FIGS. 5 and 6.

FIG. 5 depicts an example process 500 for accommodating concurrently detected branch mispredicts as well as a nuke signaled from the ROB, in accordance with embodiments. At 502 a first branch mispredict is detected at a first JEU. At 504 a second branch mispredict is detected at a second JEU concurrently (e.g., within a same instruction cycle) with the detection of the first branch mispredict. At 506 information associated with the second branch mispredict is stored in a skid buffer. In embodiments, the operations for 502, 504, and 506 may proceed similarly to those described above with regard to FIG. 3.

At 508 a nuke command or instruction is received from the ROB (e.g., ROB 118). In some embodiments, the nuke command may be an early nuke command, i.e. an early indication that the processor will nuke or is likely to nuke. At 510 the processing of the second branch mispredict is skidded such that a core clearing is scheduled for the second branch mispredict farther down in the primary JEU DP. In some embodiments this skidding is similar to the skidding described above with regard to FIG. 3, except that it is scheduled later in the DP to occur after the processing of the nuke. In some embodiments, the skid is scheduled one instruction cycle later than in the FIG. 3 example, to accommodate the nuke. At 512 one or more operations are executed for the nuke, and at 514 (e.g., after the nuke) the core clearing for the second branch mispredict is initiated when the scheduled core clearing arrives in the DP of the primary JEU. Further, in some cases the nuke processing may clear out the skid from signaling a mispredict in the later cycle if the nuke and the mispredict are on the same thread.

FIG. 6 depicts an example set of pipeline instructions to handle concurrently detected branch mispredicts along with an additional nuke command from the ROB, according to embodiments. As similarly shown in FIG. 4, FIG. 6 depicts a five-stage process for mispredict and nuke handling in primary JEU DP 604 and secondary JEU DP 606. At column 608 a first branch operation (e.g., Branch A) is scheduled on the primary JEU and a second branch operation (e.g., Branch B) is concurrently scheduled on the secondary JEU. At column 610 the branch information for Branch A is sent to other units in the processor (e.g., in a prepare-for-mispredict message).

At column 612 mispredicts are simultaneously detected by the primary JEU and the secondary JEU for Branch A and Branch B respectively. During this cycle, the primary JEU sends the mispredict message corresponding to the Branch A mispredict, instructing the other units of the processor to initiate a core-wide clearing process to clear all micro-operations younger than Branch A, as described above. During the same instruction cycle, the mispredict for Branch B triggers a skid such that the five-stage branch processing is scheduled later in the primary JEU DP (e.g., skidded).

At column 614 an early nuke command is received from the ROB. This early nuke is scheduled into the primary JEU DP to be performed after the primary JEU mispredict is signaled at column 612. Then, the skidded five-stage branch process for the second branch mispredict is delayed an additional at least one instruction cycle to column 618, such that a slot is reserved for the Branch B skid at column 618. At column 620 nuke information is sent to the other units in the processor instructing them to prepare for the nuke. At column 622 the five-step branch process for Branch B proceeds with the sending of branch information for Branch B to the other units of the processor (e.g., a prepare-for-mispredict message). At column 624 the nuke command is sent to the other units and a target address is sent to the fetch unit, and at column 626 the mispredict signal is sent to trigger the core-wide clearing for the detected Branch B mispredict. If the nuke command and the Branch B mispredict are on the same thread, the core-wide clearing operation for Branch B is suppressed because the nuke is older.

### Illustrative Operations for Promotion

FIGS. 7 and 8 illustrate an example scenario in which the secondary JEU is promoted to have access to the mispredict mechanisms normally accessible to the primary JEU. As described above, in some embodiments the signaling of a mispredict is performed through the primary JEU. However, in some cases when the primary JEU has a scheduled non-branch micro-operation (e.g., an add operation) or a null/empty operation (e.g., noop), it may be advantageous to promote the secondary JEU and enable it to take control of the various mechanisms for signaling a mispredict. In such cases, the secondary JEU is in effect acting as though it is the primary JEU, until it has completed its operations related to processing the branch and/or the branch mispredict, at which point it may be demoted back to its limited functionality status.

FIG. 7 depicts an example process 700 for promotion of the secondary JEU. At 702 a scheduled non-branch operation is detected in the first JEU's DP or it is determined that no operation is scheduled on the first JEU (i.e., it is idle). The non-branch operation may be any operation that does not involve a branch, jump, or other conditional (e.g., such as an add operation). The non-branch operation may also be a null operation (e.g., a noop). At 704 a scheduled branch operation is detected in the second JEU's DP, scheduled concurrently with the non-branch operation in the first JEU DP.

At 706 based on these detected operations of 702 and 704, the DP for the second JEU is provided with access to the buffers and/or other mechanisms for initiating a core-wide clearing process. For example, the second JEU may be provided with the means to send the prepare-for-mispredict message 120 and the mispredict message 122. At 708 the second JEU DP sends branch information to the other units of the processor warning them of a possible branch mispredict (e.g., sends a prepare-for-mispredict message). At 710 the second JEU initiates a core clearing process on detecting a mispredict on its branch operation. Though not shown in FIG. 7, after performing these operations the secondary JEU may be demoted and returned to its limited functionality status.

Moreover, in some embodiments a policy may dictate that promotion is permitted only in situations where the first JEU is idle (i.e., no operation is scheduled) simultaneously with a branch operation on the second JEU. In some embodiments, promotion of the second JEU may be determined when there are no other operations scheduled on the first JEU that use the mispredict signals (i.e., that use the taken address wires to the fetch unit).

FIG. 8 illustrates example DPs for the primary and secondary JEUs according to this promotion scenario. The two rows show the primary JEU DP 804 and secondary JEU DP 806 respectively. At column 808 a non-branch operation has been scheduled in the primary JEU DP, and a branch operation for Branch B has been scheduled in the DP for the secondary JEU.

In this example, because a non-branch operation is detected in the primary JEU DP, the secondary JEU is promoted and is therefore able to itself send the branch information for Branch B to the other units in the processor at column 810. Moreover, the secondary JEU is also able to send the mispredict message for Branch B to initiate a core-wide clearing process at column 812. In some embodiments after the secondary JEU completes its processing for Branch B (e.g., after the branch is retired), the secondary JEU is demoted and returns to its limited functionality state such that it is no longer able to directly initiate a clearing process in response to a mispredict.

### Illustrative Operations for Handling Older Mispredict/Nuke

Some embodiments support an additional example scenario in which an older mispredict is detected on the primary JEU after the secondary JEU skids for the same thread. This scenario is similar to the first skid scenario described above with regard to FIGS. 3 and 4, but with an additional characteristic. After the secondary JEU skids, another mispredict is detected on the primary JEU that is older in program order than the detected mispredict secondary JEU. In this case, all operations younger than this newly detected older mispredict are cleared out, including the skidded secondary JEU branch operations themselves. In embodiments (not limited to those illustrated in FIGS. 3 and 4), no mispredict is allowed to signal from either JEU or allowed to enter a skid when an older mispredict is already in the skidding process.

FIG. 9 depicts an example process for handling such cases. At 902 a first branch mispredict is detected at the first JEU. At 904 a second branch mispredict is detected at the second JEU, concurrently with the detection of the first branch mispredict (e.g., in a same instruction cycle). At 906 information related to the second branch mispredict is stored in the skid buffer. At 908 a core clearing is scheduled in the DP of the first JEU based on the stored information in the skid buffer. In some embodiments, the core clearing is scheduled at a predetermined number of instruction cycles after detection of the second branch mispredict (e.g., six instruction cycles). In some embodiments, 902, 904, 906, and 908 proceed similarly to corresponding operations described above with regard to FIG. 3.

At 910 an indication is received from the first JEU of a third branch mispredict that is older in program order than either the first or second branch mispredicts. At 912, in response to this indication, the initiation of the previously scheduled core clearing is blocked. In some embodiments, this includes deleting or invalidating the stored information regarding the second branch mispredict from the skid buffer, and/or setting the skid counter back to its initialization state as if there had been no skid at all for the second branch processing. In some embodiments, each mispredict that is detected by the primary JEU is compared to any mispredicts that are currently being skidded. If the newly detected mispredict is older in program order than the previously skidded mispredicts, those previously skidded mispredicts are blocked and/or cleared from the skid buffer. In this way, some embodiments may ensure that no mispredict is signaled that is younger than another detected and skidded mispredict.

Some embodiments may accommodate similar though somewhat different scenarios in which an older nuke command is received from the ROB, i.e., a nuke command that is older in program order than either the first or second branch mispredicts on the same thread. In such cases, indication of an older nuke prompts the blocking and/or clearing of a previously skidded mispredict on the second JEU as described above.

FIG. 10 illustrates example DPs for the primary and secondary JEUs according to this example scenario. The two rows show the primary JEU DP 1004 and secondary JEU DP 1006 respectively. At column 1008 a branch operation for a first branch, Branch A, has been scheduled in the primary JEU DP, and a branch operation for a second branch, Branch B, has been scheduled in the DP for the secondary JEU.

At column 1010 the branch information for Branch A is sent from the primary JEU DP to other units in the processor (e.g., a prepare-for-mispredict message is sent). At column 1012 the primary JEU signals a mispredict on Branch A, to initiate a core clearing process for that branch. In the same instruction cycle, the secondary JEU detects a mispredict on Branch B and skids as described above. After the skid, an older mispredict (or nuke command) is detected by the primary JEU. Although FIG. 10 depicts this older mispredict detected two cycles after the skid, embodiments support the detection of the older mispredict during any cycle after the skid and before the skidded mispredict signal is sent (e.g., five cycles later). Based on detection of the older mispredict, the skid buffer is cleared and the skidded mispredict for Branch B is blocked. This older branch mispredict that clears the skid buffer could come from either the primary or secondary JEU. In either case the appropriate actions for the combination branches and mispredicts for that cycle may be applied in accordance with the cases previously described.

The examples above describe cases when there is a branch in the skid, but the skid has not yet reached the primary JEU when the primary JEU signals an older mispredict or nuke. Some embodiments support an additional case when the skid is active and has not yet reached the primary JEU, and the secondary JEU has an older mispredict while the first JEU is active with another branch. In such cases the secondary JEU also skids, and because it is older it clears the younger mispredict out of the skid, and restarts the skid process with this older secondary mispredict.

### Summary of Example Scenarios

Table 1 summarizes possible scenarios and actions taken in response to those scenarios, according to embodiments. In Table 1, the first column describes the information (e.g., a signal) received on a port for the Primary JEU. The second column describes information received on a port for the Secondary JEU. The third column lists information received on a port for the ROB. The fourth column describes the action taken in each scenario.

TABLE 1

| | | Secondary | | |
|---|---|---|---|---|
| | Primary JEU | JEU | ROB | Action Taken |
| 1 | Mispredict | Mispredict | | Drop mispredict on Secondary |
| | (older than | | | JEU |
| | secondary, on | | | |
| | same thread) | | | |
| 2 | Mispredict | Mispredict | | Skid Secondary JEU (e.g., |
| | (younger than | | | FIGS. 3 and 4) |
| | secondary, on | | | |
| | same thread) | | | |
| 3 | Mispredict (on | Mispredict | | Skid Secondary JEU (e.g., |
| | another | | | FIGS. 3 and 4) |
| | thread) | | | |
| 4 | No mispredict | Mispredict | | Skid Secondary JEU (e.g., |
| | | | | FIGS. 3 and 4) |
| 5 | Non-branch | Mispredict | | Promote Secondary JEU (e.g., |
| | operation (or | | | FIGS. 7 and 8) |
| | no | | | |
| | operation/idle) | | | |
| 6 | Executes a | Mispredict | Nuke | Skid Secondary JEU after |
| | branch | | | Nuke (e.g., FIGS. 5 and 6) |
| 7 | Executes a | Mispredict | Nuke | Block Skid of Secondary JEU |
| | branch | | (older) | (e.g., FIGS. 9 and 10) |
| 8 | No mispredict | No | | No action |
| | | mispredict | | |

In the example of row 1, the primary and secondary JEUs are each executing a branch operation in a same thread and each mispredicts. If the mispredict on the primary JEU is older, then a core clearing process initiated for this older mispredict also clears operations associated with the second mispredict, and therefore no action is taken to skid the branch on the secondary JEU.

In the example of row 2, the primary and secondary JEUs are each executing a branch operation in a same thread and each mispredicts. In this example scenario, the mispredict on the primary JEU is for a younger branch, and the branch on the secondary JEU skids as described above with regard to FIGS. 3 and 4.

In the example of row 3, the primary and secondary JEUs are executing branch operations on different program threads, and each branch mispredicts. Because the branches are on different, independently executing threads, both mispredicts are handled (e.g., a core clearing process is initiated to account for each mispredict). Thus, in this example scenario, the secondary JEU branch skids as described above with regard to FIGS. 3 and 4.

In the example of row 4, a branch executed by the primary JEU does not mispredict and a branch executed by the secondary JEU does mispredict. In this example, a core clearing process is to be initiated for the secondary JEU's branch and a skid is triggered to enable the secondary JEU access to the core clearing functionality of the primary JEU.

In the example of row 5, a non-branch operation (or no operation) is executing on the primary JEU (or the primary JEU is idle) and the secondary JEU is executing a branch operation. In this example, the secondary JEU is promoted as described above with regard to FIGS. 7 and 8.

In the example of row 6, a branch is executing on the primary JEU and secondary JEU mispredicts requiring a skid, and a signal is received the ROB requesting the same primary JEU dispatch slot as the skidded branch to process a nuke. In this example, the skid is delayed to take place after the nuke operations as described above with regard to FIGS. 5 and 6.

In the example of row 7, a branch is executing on the primary JEU and the secondary JEU mispredicts requiring a skid, and the primary JEU subsequently executes a ROB-requested nuke command that is older than the mispredict for the same thread. That is, the ROB signal is a nuke signal that occurs between the time the skid was written and the time the skid was read. In this example, the skid of the secondary JEU's branch is blocked as described above with regard to FIGS. 9 and 10.

In the example of row 8, the primary and secondary JEUs are each executing a branch operation, but neither mispredicts. Thus, in this example no action is performed.

Though not listed in Table 1, some embodiments support an additional case where the secondary JEU needs a skid but there is already a branch in the skid buffer. If the newly skidded branch is younger than the one that is currently in the skid buffer, then its mispredict is cleared by the older mispredict that is currently in the skid buffer. However, if the newly skidded branch is older than the one that is currently in the skid buffer, then the skid buffer is cleared and the newly skidded branch starts its own skid process.

Some embodiments may support an alternative approach in which the skidded branch micro-operations are redispatched by the scheduler down the primary JEU's pipeline, rather than skidding the result from the secondary JEU. This may still consume a certain number of cycles (e.g., six cycles) before the branch would arrive at the primary JEU as in the skidding cases discussed above. However, in many cases compare and branch micro-operations are combined into a single “fused” micro-operation by the micro-architecture. In such situations, the skid mechanism could result in lower power because the comparison operation is not re-computed. The comparison result is ready immediately after the branch executes on the secondary JEU and may be used by another consumer the following cycle rather than waiting for the redispatch to complete.

### Illustrative Techniques for Enabling/Disabling the Secondary JEU

Some embodiments provide techniques and/or mechanisms for activating and/or deactivating the secondary JEU. In some cases, the secondary JEU may be activated in circumstances when a certain number of branch operations are being executed in the processor and/or based on a number of correct and incorrect branch predictions for the executed branch operations. The secondary JEU may be deactivated during other periods, to lower power consumption in the processor or to otherwise optimize its operation.

Disabling the secondary JEU under certain circumstances may provide advantages for processor performance, given that the longer latency of the skidding operation to handle a mispredict may have adverse performance impact. For example suppose the secondary JEU is enabled and can execute and/or evaluate a branch three cycles earlier than otherwise, but then a branch on the secondary JEU mispredicts, which incurs a six cycle delay as in the example shown above. Under such circumstances the mispredict action of core-wide clearing and restarting fetch is actually three cycles later (i.e., 6−3) than otherwise. In some cases, this may not be a beneficial tradeoff.

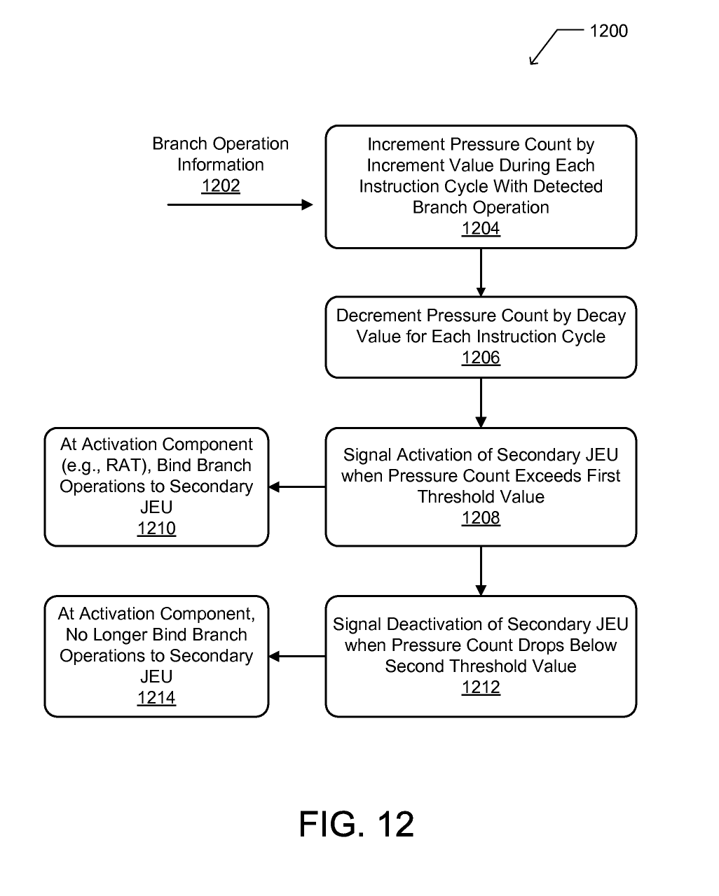

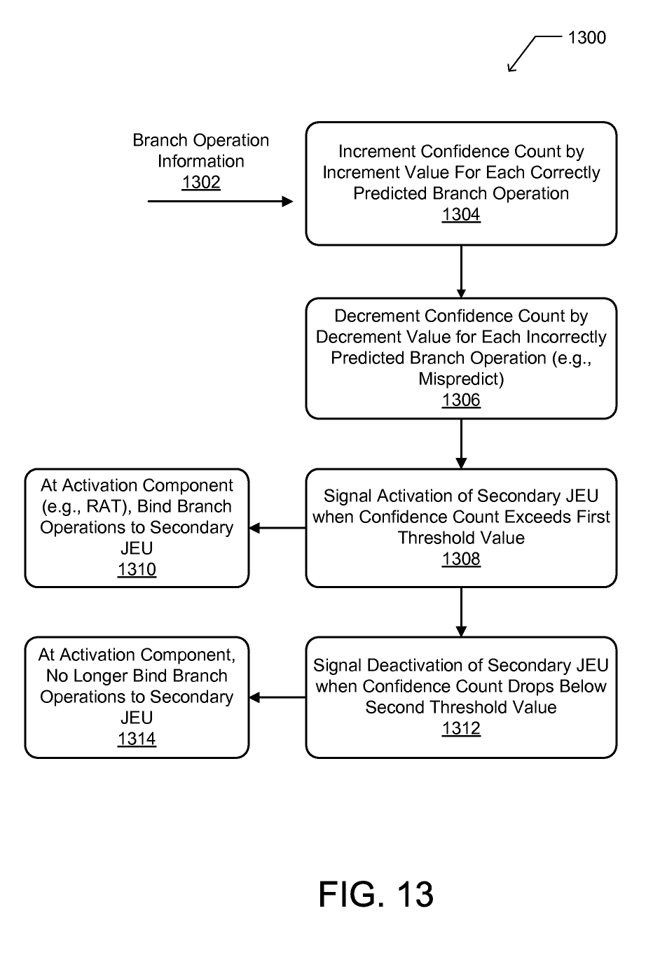

FIG. 11 depicts an example processor architecture 100 with similar elements to those shown in FIG. 1, and including additional elements to illustrate example operations for activating and/or deactivating secondary JEU 112. As shown, counter 128 may receive feedback information 1102 from primary JEU 110 and/or feedback information 1104 from secondary JEU 112. In some embodiments, counter 128 includes a pressure counter that maintains a pressure count based on a number of branch operations executed by primary JEU 110 and/or secondary JEU 112 (e.g., when secondary JEU 112 is active). In such embodiments, feedback information 1102 and 1104 includes information regarding a number of branch operations executed by the JEUs. In other embodiments, counter 128 includes a confidence counter that maintains a confidence count based on a number of correct and incorrect branch predictions detected by primary JEU 110 and/or secondary JEU 112 (e.g., when secondary JEU 112 is active). In such embodiments, feedback information 1102 and 1104 includes information regarding the number of correct and incorrect branch predictions detected in either JEU. Example operations for the pressure counter and the confidence counter are described further herein with regard to FIGS. 12 and 13.

Based on the received feedback information, counter 128 may send a signal 1106 to RAT/ALLOC 102 or other activation component to indicate that the secondary JEU 112 is to be activated (if it is currently inactive), or deactivated (if it is currently active). In this way, the counter 128 may determine when the secondary JEU 112 is to be active based on the branch operation information received. If signal 106 indicates that the secondary JEU 112 is to be activated, RAT/ALLOC 102 may respond to the signal by activating the secondary JEU 112.

In some embodiments, activating the secondary JEU 112 includes binding one or more branch operations to a port of the secondary JEU 112 or the secondary JEU DP 108, such that the branch operations are resolved (e.g., executed) in the secondary JEU 112. In some embodiments, RAT/ALLOC 102 or other activation component employs one or more port balancing criteria or algorithms to balance the load of branch operations between the two JEUs. In some embodiments, these criteria may include selecting a least-loaded port (e.g., as determined by tracking the number of unexecuted micro-operations for that port still residing in the reservation station). In some embodiments when the port loads are somewhat evenly balanced, a load balancing method such as round robin may be employed. If signal 106 indicates that the secondary JEU 112 is to be deactivated, RAT/ALLOC 102 may respond to the signal by deactivating the secondary JEU 112 (e.g., no longer binding any branch operations to a port of the secondary JEU or its DP).

In some embodiments, additional feedback information may be employed by the counter 128 to determine when to activate or deactivate the secondary JEU 112. For example, the primary JEU DP 106 may send feedback information 1108 and/or the secondary JEU DP 108 may send feedback information 1110 that includes information regarding branch operations scheduled within either DP. RAT/ALLOC 102 may also send feedback information 1112 to counter 128. In some embodiments, this feedback information may include one or more of the following: branch operation density in time (e.g., number of branch operations per unit of time), branch operation density as a percentage of total operations allocated, density of all operations sent to the same dispatch port that the primary JEU is connected to (e.g., either in time or as a percentage of total operations), or other information. Moreover, in some embodiments a different component of architecture 100 (e.g. scheduler 104) may activate or deactivate the secondary JEU 112 based on signals received from counter 128.

FIG. 12 depicts an example process 1200 for activating and/or deactivating a secondary JEU based on branch operation information. In this example, counter 128 is operating as a pressure counter and determining when to activate or deactivate the secondary JEU based on detected branch operations executed in the processor. As shown, process 1200 receives branch operation information 1202. Such branch operation information may include feedback information 1102 received from the primary JEU. Additionally, when the secondary JEU is active, branch operation information may also include feedback information 1104 from the secondary JEU. Branch operation information 1202 may further include the additional feedback information 1108, 1110, and/or 1112 shown in FIG. 11.

At 1204 a pressure count is incremented by an increment value during each instruction cycle in which a branch operation is executed, as determined from the received branch operation information 1202. In some embodiments, the pressure count is a binary counter value of n bits. For example, a pressure count may be a four bit saturating counter that floors at 0 and that ceilings at a maximum value of 15. At 1206 the pressure count is decremented by a decay value for each instruction cycle.

At 1208 the pressure counter compares the pressure count to a threshold value and signals that the secondary JEU is to be activated when the pressure count exceeds the threshold value. This signal may be sent to an activation component, for example RAT/ALLOC 102 as described above. On receiving the signal, the activation component begins binding new (e.g., incoming) branch operations to a port of the secondary JEU or its DP at 1210. At 1212 the pressure counter may signal that the secondary JEU is to be deactivated when the pressure count drops below the threshold value. On receiving the deactivation signal, the activation component discontinues binding new branch operations to the secondary JEU at 1214.

In some embodiments the activation component may operate according to a hysteresis in which the secondary JEU is activated when the pressure count climbs above a first (e.g. activation) threshold value, and is deactivated when the pressure count drops below a second (e.g., deactivation) threshold value that is lower than the first threshold value.

In some embodiments, a goal of the pressure counter is to enable or disable the secondary JEU when a significant number of branch operations are being executed, because the secondary JEU branch misprediction latency is six cycles longer than that of the primary JEU. Embodiments may employ various values for the increment value, decay value, and/or threshold value. For example, for a four-bit pressure count the increment value A may have a value A=2, the decay value C may have a value C=1, and the threshold value may be D=8. Thus, in this example the secondary JEU may be activated when the pressure count >8. In some embodiments, a same increment value A may be used for branch operations detected on the primary JEU as well as for branch operations detected on the secondary JEU, such that the pressure count is incremented by A when a branch operation is detected on either JEU. In other embodiments, a different increment value B may be employed to increment the pressure count for branch operations detected on the secondary JEU.

In some embodiments, the variables of A, B, C, and/or D may be static values implemented in the hardware of a processor. In other embodiments, these variables may be stored in control registers and may be dynamically controlled by the software, operating system, and/or basic input/output system (BIOS) of the processor during its operation. In some embodiments, a dynamic adjustment mechanism (e.g., a hill-climbing algorithm) may be employed that attempts various values of one or more of these variables and measures changes in a secondary JEU mispredict frequency and/or other performance benchmarks of the processor, and adjusts the values to maximize processor performance or based on other criteria.

In some embodiments, the pressure counter mechanism may be thread-agnostic, i.e., the mechanism keeps a single pressure count for all threads running on the core of the processor. In other embodiments, the pressure counter mechanism may be duplicated such that there is one mechanism (e.g., one pressure count value) operating for each executing thread. In some embodiments, different values for variables A, B, C, and/or D above may be used depending on whether the pressure counter mechanism is thread-agnostic or thread-specific.

FIG. 13 depicts an example process 1300 for activating and/or deactivating a secondary JEU based on branch operation information. In this example, counter 128 is operating as a confidence counter and determining when to activate or deactivate the secondary JEU based on correctly and incorrectly predicted branch operations executed in the processor. As shown, process 1300 receives branch operation information 1302. As described above, this information may include feedback information 1102, 1104, 1108, 1110, and/or 1112.

At 1304 a confidence count is incremented by an increment value for each correctly predicted branch operation executed in the processor, as determined from the received branch operation information 1302. In some embodiments, the confidence count is a binary counter value of n bits. For example, a confidence count may be a six bit saturating counter that has a minimum value of 0 and a maximum value of 63. At 1306 the confidence count is decremented by a decrement value for each incorrectly predicted branch operation (e.g., for each mispredict) executed in the processor.

At 1308 the confidence counter compares the confidence count to a threshold value and signals that the secondary JEU is to be activated when the confidence count exceeds the threshold value. This signal may be sent to an activation component, for example RAT/ALLOC 102 as described above. On receiving the signal, the activation component begins binding new (e.g., incoming) branch operations to a port of the secondary JEU or its DP at 1310. At 1312 the confidence counter may signal that the secondary JEU is to be deactivated when the confidence count drops below the threshold value. On receiving the deactivation signal, the activation component discontinues binding new branch operations to the secondary JEU at 1314.

In some embodiments the activation component operates according to a hysteresis such that the secondary JEU is activated when the confidence count goes above a first (e.g. activation) threshold value and deactivated when the confidence count goes below a second (e.g., deactivation) threshold value that is lower than the first threshold value.

In some embodiments, a six-bit confidence counter may have an increment value A=1, a decrement value of B=32, and a threshold value of D=32. As described above with regard to the pressure counter, these values may be static or dynamically altered during operations of the processor. Moreover, the confidence counter mechanism may be thread-agnostic or thread-specific, as described above with regard to the pressure counter.

With regard to either or both of the pressure counter or confidence counter embodiments described above it is noted in some embodiments no special conditions may be necessary to back off on the use of the secondary JEU. In some cases, recovery from a branch misprediction may cause bubbles in the pipeline that may naturally cause the counter to decrease and eventually drop below the threshold thus disabling micro-operation binding to the secondary JEU.

### CONCLUSION

Although the techniques have been described in language specific to structural features and/or methodological acts, it is to be understood that the appended claims are not necessarily limited to the specific features or acts described. Rather, the specific features and acts are disclosed as example forms of implementing such techniques.

What is claimed is:

1. A processor comprising:
a first jump execution unit (JEU) for branch operation evaluation;
a second JEU for branch operation evaluation, the second JEU to operate in parallel with the first JEU; and
an activation component to activate the second JEU based at least partly on a number of branch mispredicts identified by the first JEU.

2. The processor of claim 1, wherein the activation component employs a port binding algorithm.

3. The processor of claim 1, further comprising a confidence counter to track a confidence count based on the number of branch mispredicts, and to signal the activation component to activate the second JEU when the confidence count exceeds an activation confidence threshold.

4. The processor of claim 3, wherein the confidence counter signals the activation component to deactivate the second JEU when the confidence count drops below a deactivation confidence threshold.

5. The processor of claim 3, wherein the confidence count is dynamically adjustable.

6. The processor of claim 3, wherein the confidence count is further based on a second number of branch mispredicts identified by the second JEU.

7. The processor of claim 1, the first JEU and the second JEU operating in parallel to concurrently detect a first mispredict on a first branch and a second mispredict on a second branch.

8. A processor comprising:
a first jump execution unit (JEU) to evaluate a first branch operation for a first branch mispredict;
a counter to count a number of branch operations evaluated by the first JEU; and
a second JEU that is activated at least partly based on the counted number of branch operations, the second JEU activated to evaluate a second branch operation for a second branch mispredict during a same instruction cycle as the first JEU evaluates the first branch operation.

9. The processor of claim 8, further comprising an activation component to activate the second JEU using a port binding algorithm.

10. The processor of claim 9, wherein the counter signals the activation component to activate the second JEU based on the counted number of branch operations.

11. The processor of claim 8, wherein the counter counts the number of branch operations for all threads executing on the processor.

12. The processor of claim 8, wherein the counter counts the number of branch operations separately for each thread executing on the processor.

13. The processor of claim 8, wherein the counter is a pressure counter that increments a pressure count in response an execution of a branch operation by either the first JEU or the second JEU, and that decrements the pressure count during each instruction cycle.

14. The processor of claim 13, wherein the pressure counter signals an activation component of the processor to activate the second JEU when the pressure count exceeds an activation threshold.

15. The processor of claim 13, wherein the pressure counter signals an activation component of the processor to deactivate the second JEU when the pressure count drops below a deactivation threshold.

16. The processor of claim 8, wherein the counter is a pressure counter that increments a pressure count in response to the first JEU executing a branch operation, and the decrements the pressure count during each instruction cycle.

17. A method comprising:
resolving a first branch by a primary jump execution unit (JEU) of a processor;
decrementing a pressure count by a decay value during each of a plurality of instruction cycles;
incrementing the pressure count by an increment value during each of the plurality of instruction cycles in which a branch operation is detected; and
activating a secondary JEU of the processor to operate in parallel with the primary JEU based on the pressure count exceeding an activation threshold value, the secondary JEU activated to resolve a second branch during a same instruction cycle as the primary JEU resolves the first branch.

18. The method of claim 17, wherein activating the secondary JEU includes sending a signal to a port binding component of the processor, the port binding component binding one or more branch operations to a port of the secondary JEU in response to the signal.

19. The method of claim 17, further comprising deactivating the secondary JEU when the pressure count falls below a deactivation threshold value.

20. The method of claim 19, wherein at least one of the decay value, the increment value, the activation threshold value, or the deactivation threshold value is dynamically adjustable.

21. The method of claim 17, further comprising binding one or more branch operations to the primary JEU and the secondary JEU based on a balancing criterion, when the secondary JEU is active.

22. A method comprising:
resolving a first branch by a primary jump execution unit (JEU) of a processor;
incrementing a confidence count by an increment value, for each correctly predicted branch operation;
decrementing the confidence count by a decrement value, for each incorrectly predicted branch operation; and
activating a secondary jump execution unit (JEU) of the processor to operate in parallel with the primary JEU based on the confidence count exceeding an activation threshold value, the secondary JEU activated to resolve a second branch during a same instruction cycle as the primary JEU resolves the first branch.

23. The method of claim 22, wherein activating the secondary JEU includes sending a signal to a port binding component of the processor, the port binding component binding one or more branch operations to a port of the secondary JEU in response to the signal.

24. The method of claim 22, further comprising deactivating the secondary JEU when the confidence count falls below a deactivation threshold value.

25. The method of claim 24, wherein at least one of the increment value, the decrement value, the activation threshold value, or the deactivation threshold value is dynamically adjustable.

26. The method of claim 22, wherein activating the secondary JEU includes:
sending a signal to a port binding component of the processor based on the confidence count exceeding the activation threshold value; and
at the port binding component, binding one or more branch operations to the primary JEU or the secondary JEU based on a port balancing criterion and in response to the signal.

27. A system comprising:
at least one processing unit including:
a first jump execution unit (JEU) for branch operation evaluation;
a second JEU for branch operation evaluation; and
an activation component to activate the second JEU based at least partly on detected branch operations of the first JEU, the second JEU activated to operate in parallel with the first JEU.

28. The system of claim 27, wherein the activation component is a port binding component of the at least one processing unit.

29. The system of claim 27, wherein the at least one processing unit further includes a counter component that signals the activation component to activate the second JEU based at least partly on the detected branch operations.

30. The system of claim 29, wherein the counter component is a pressure counter that keeps a pressure count for a number of branch operations executed by the first JEU, and that signals the activation component to activate the second JEU when the pressure count exceeds an activation threshold value.

31. The system of claim 29, wherein the counter component is a pressure counter that keeps a pressure count for a number of branch operations executed by the first JEU and the second JEU, and that signals the activation component to activate the second JEU when the pressure count exceeds an activation threshold value.

32. The system of claim 29, wherein the counter component is a confidence counter that keeps a confidence count for a number of mispredicts detected during branch operations executed by the first JEU, and that signals the activation component to activate the second JEU when the confidence count exceeds an activation threshold value.

33. The system of claim 29, wherein the counter component is a confidence counter that keeps a confidence count for a number of mispredicts detected during branch operations executed by the first JEU and the second JEU, and that signals the activation component to activate the second JEU when the confidence count exceeds an activation threshold value.
